(19) United States
(12) Patent Application Publication
(10) Pub. No.: US 2014/0277905 A1
(43) Pub. Date: Sep. 18, 2014

(54) METHODS AND APPARATUS TO MANAGE A FLEET OF WORK MACHINES

(71) Applicant: DEERE & COMPANY, Moline, IL (US)

(72) Inventor: Noel Wayne Anderson, Fargo, ND (US)

(73) Assignee: Deere & Company, Moline, IL (US)

(21) Appl. No.: 13/841,299

(22) Filed: Mar. 15, 2013

(51) Int. Cl. G07C 5/08

(52) U.S. Cl. CPC G07C 5/08
USPC 701/29.3

(57) ABSTRACT

Methods and apparatus are disclosed for managing a fleet of work machines. An example method disclosed herein includes determining corresponding performance metrics for a plurality of machine configurations to complete corresponding missions at a work site of an operation; assigning a machine configuration of the plurality of machine configurations to the plurality of missions based on the performance metrics.

### FIELD OF THE INVENTION

This disclosure relates generally to work machines, and, more particularly, to methods and apparatus to manage a work machine fleet.

### BACKGROUND

Work machines for construction, agricultural, or domestic applications may be powered by an electric motor, an internal combustion engine, or a hybrid power plant including an electric motor and an internal combustion engine. For example, in agricultural uses an operator may control the machine to harvest crops and/or plant seed, or accomplish some other task in a work area. Machine configurations may include multiple machines coupled together to provide additional traction and/or power to complete a task. The machine configurations may include an implement (e.g., a field plow, a cultivator, a tiller, a planter, a seeder, a scraper, a blade, etc.).

### SUMMARY

An example method disclosed herein includes determining a performance metric for corresponding machine configurations of a plurality of machine configurations to execute a mission at a corresponding work site based on at least one of characteristics of the machine configuration or characteristics of the work site; and assigning a machine configuration of the plurality of machine configurations to the work site for execution of the mission based on the performance metrics.

An example apparatus disclosed herein includes a mission analyzer to determine a performance metric for corresponding machine configurations of a plurality of machine configurations to execute a mission at a corresponding work site based on at least one of characteristics of the machine configuration or characteristics of the work site; and a fleet assigner to assign a machine configuration of the plurality of machine configurations to the work site for execution of the mission based on the performance metrics.

An example machine readable storage medium is disclosed herein having machine readable instructions which when executed cause a machine to determine a performance metric for corresponding work machine configurations of a plurality of work machine configurations to execute a mission at a corresponding work site based on at least one of characteristics of the work machine configuration or characteristics of the work site; and assign a work machine configuration of the plurality of work machine configurations to the work site for execution of the mission based on the performance metrics.

### BRIEF DESCRIPTION OF THE DRAWINGS

FIG. 1 is a schematic illustration of an example work machine operation including a fleet manager to manage the fleet of work machines for a plurality of work sites.

FIG. 2A illustrates an example host machine in the fleet of FIG. 1.

FIG. 2B illustrates an example auxiliary machine in the fleet of FIG. 1.

FIG. 3 is a block diagram of an example implementation of the fleet manager of FIG. 1.

FIG. 4 is a flowchart of an example method, which may be implemented by the fleet manager of FIG. 3 using machine readable instructions to assign machine configurations to work sites.

FIG. 5 illustrates example machine configurations of the work machines in the fleet of FIG. 1 that may be analyzed by the fleet manager of FIG. 3.

FIG. 6A illustrates a topographic view of an example work site.

FIG. 6B illustrates an example table generated from the work cells of FIG. 6A indicating performance metrics of the corresponding cells.

FIG. 7 illustrates an example performance metric table generated by the fleet manager of FIGS. 1 and/or 3.

FIG. 8 is a block diagram of an example processor platform to execute or utilize the process of FIG. 4 and other methods to implement the example fleet manager of FIGS. 1 and/or 3.

### DETAILED DESCRIPTION

Methods and apparatus for managing a fleet of work machines are disclosed. The work machines are assigned to work sites to be used in one or more machine configurations. The machine configurations may include one or more powered machine(s) (i.e., a machine powered by an electric motor, an internal combustion engine (ICE), a hybrid power plant including an electric motor and an internal combustion engine, etc.) and/or one or more non-powered or powered implements (e.g., a field plow, a cultivator, a tiller, a planter, a seeder, etc.). Example machine configurations are assigned to complete one or more task(s) (e.g., plow a field, plant seed, remove snow, etc.) at corresponding work sites. Methods and apparatus disclosed herein include assigning work machines to the work site(s) based on one or more factor(s) including: an arrangement of the machine configuration, a desired work path of the machine configuration, an alignment of the machine configuration, a location of the machine configuration, machine characteristic(s) of the machine(s) of the machine configuration, and/or work path characteristic(s) of the desired work path.

FIG. 1 is a schematic illustration of an example machine fleet management system 100 including a fleet manager 110 to manage a work machine fleet 120. The work machine fleet 120 includes three host machines 122, 132, 134 and three auxiliary machines 140, 144, 136. The three host machines 122, 124, 126 are representative of the different models of host machines. Accordingly, the host machines 122, 124, 126 have different characteristics (e.g., features such as sensors, equipment, machine health, component health, usages, etc.), and/or different power specifications (e.g., power ratings, tractive power, energy storage capacity, fuel usage, power sources, etc.) such that they have different performance metrics from one another. As described herein, performance metrics include, but are not limited to, fuel consumption, energy consumption, fuel cost, emissions, operating rates, traveling rates, labor requirements (e.g., some machines may require an operator expertise level), etc.). In some examples, the host machines 122, 124, 126 may have the same or similar characteristics and/or power specifications such that they operate in the same or similar manner. Furthermore, though only the three host machines 122, 124, 126 are shown in the example of FIG. 1, in some examples, the machine fleet 120 may include more or fewer than three host machines.

Similarly to the host machines 122, 124, 126, in the example of FIG. 1, the auxiliary machines 132, 134, 136 are different models from one another, and thus have different machine characteristics and/or power specifications. However, in some examples, the auxiliary machines 132, 134, 136 may have the same or similar characteristics and/or power specifications such that they operate in the same or similar manner. Furthermore, though only the three auxiliary machines 132, 134, 136 are shown in the example of FIG. 1, in some examples, the machine fleet 120 may include more or fewer than three auxiliary machines.

The example work sites 140, 142, 144 are representative of locations at which machine configurations of the machines 122, 124, 126, 132, 134, 136 of the fleet 120 are to perform one or more mission(s) (e.g., plow a field, till a field, remove snow, transport materials, etc.). The example work sites 140, 142, 144 have different topographic contours from one another. In the illustrated example, first work site 140 includes a slope 141 (relative to the contour lines), the second work site 142 is relatively flat (represented by the spread contour lines), and the third work site 144 includes a hill 145 and some steep contours (represented by the close contour lines). Though only the three work sites 140, 142, 144 are shown in the example of FIG. 1, in some examples, the fleet management system 100 may include more or fewer than three work sites.

The example fleet manager 110 of FIG. 1 identifies the work machines 122, 124, 126, 132, 134, 136 of the fleet, determines possible machine configurations of the work machines 122, 124, 126, 132, 134, and assigns the machine configurations to the work sites 140, 142, 144 to complete missions based on one or more performance metric(s). The performance metric(s) may include one or more of fuel cost, machine emissions (e.g., carbon dioxide (CO2), particulates, or NOx gases generated), time to complete the missions, overall costs (e.g., costs based on fuel, labor, and equipment usage), a probability of completing a mission (e.g., based on capability of traversing the work site without getting stuck (e.g., due to one or more of soil conditions, topography, etc.), running out of fuel and/or stored energy, etc.).

FIG. 2A illustrates an example host machine 220 that may implement one of the host machines 122, 124, 126 of FIG. 1. The host machine 220 of FIG. 2A may be a tractor or other similar machine used for agricultural equipment, construction equipment, turf care equipment, snow removal equipment, etc. The host machine 220 may be operator-controlled, autonomous (without an operator and/or cab), semi-autonomous or any combination of the foregoing characteristics. An autonomous machine is self-guided without operator intervention or with minimal operator intervention. A semi-autonomous machine may provide guidance instructions to an operator or driver who executes the guidance instructions and may use independent judgment with respect to the instructions.

The example host machine 220 of FIG. 2A includes, among other components, an operator cab 221, an internal combustion engine (ICE) 222, host measurement devices 224, ground engaging elements (e.g., wheels or a track) represented by wheels 226, and a host connector 228. An operator may control the host machine 220 via operator controls of the operator cab 221. Machine characteristics and/or power specifications (and thus performance metrics) of the host machine 220 depend on at least one of the power rating of the ICE 222, the size and type of the wheels 206 (which may be replaced by or used in addition to tracks), the power rating of the host connector 228, etc.

The host measurement devices 222 of FIG. 2A may be one or more devices including one or more Global Positioning System (GPS) receiver(s) to determine a location of the host machine 220. An example GPS receiver included in the host measurement devices 222 may include a receiver with a differential correction device or another location-determining receiver. The host measurement devices 222 of FIG. 2A may include machine gauges (e.g., fuel gauges, temperature gauges, etc.) and/or sensors (e.g., draft sensors, load sensors, proximity sensors, inclinometers, braking sensors, etc.) to determine corresponding states and/or characteristics of the host machine 220, such as load, fuel, power levels, spatial configuration (i.e. one or more proximate distance(s) between machines and/or alignment of a machine configuration including the host machine 220), etc. The example host measurement devices 222 may include one or more sensor(s) to determine characteristics and/or work area/work path conditions such as soil conditions, topography, vegetation conditions/density, etc. In some examples, the host measurement devices 222 include data monitors/retrievers (e.g., a mobile device (e.g., a smartphone, a tablet computer, etc.), a computer, etc.) that retrieve data (e.g., soil maps, weather data, moisture data, topographical data, etc.) from a network (e.g., the Internet). The host measurement devices 222 may communicate with other devices or machines via the host connector 228.

The example host connector 228 (e.g., one or more of a power take-off (PTO), a drawbar hitch, hydraulic connectors, electrical connectors, communication connectors, control signal connectors, etc.) enables the host machine 122 to mechanically, hydraulically, and/or electrically connect to an implement (e.g., a plow, a cultivator, a tiller, a planter, a seeder, etc.) and/or auxiliary machine 230 of FIG. 2B.

FIG. 2B illustrates an example auxiliary machine 230 that may implement one of the auxiliary machines 132, 134, 136 of FIG. 1. The Multiple combinations of the host machine 122 and the auxiliary machine 230 are used to create machine configurations to be assigned to work sites, as described below.

In the example of FIG. 2B, the auxiliary machine 230 includes a machine controller 232, auxiliary measurement devices 234, a battery 236, one or more motor(s) 238 connected to wheels 240, and a first auxiliary connector 242. The auxiliary machine 230 of FIG. 2B may also include an ICE 246 and generator 248 that may be used to charge the battery 222 and/or provide electric current to the motor(s) 238. In some examples, the auxiliary machine 230 does not include the ICE 246, and an alternative power source (e.g., a fuel cell) provides power to the motor(s) 238. The machine controller 232 controls power and/or steering to the wheels 240. The machine controller 232 may be implemented by a machine controller that automatically controls the steering and/or power to the wheels (see U.S. patent application Ser. No. ______ (Attorney Docket No. P21234, herein incorporated by reference). In some examples, the machine controller 232 is located on a host machine (e.g., the host machine 220) coupled to the auxiliary machine 230 via one or more of the auxiliary connectors 242, 244. In such examples, the host connector 228 and/or electrical connections associated with the host connector 2228 facilitate(s) communication between the host machine 220 and the auxiliary machine 230 via one or more of the auxiliary connectors 242,244, such that the host machine 220 provides control signals and/or power instructions from an operator and/or data from the host measurement devices 224 to the machine controller 232 on the auxiliary machine 230 (e.g., steering controls, power controls for the motor 238, etc.).

The machine controller 232 may be used to control the auxiliary machine 230 (and/or the host machine 220 in some examples) to follow a desired trajectory or to traverse a desired work path. Thus, in the example of FIG. 2B, the auxiliary machine 230 may be an autonomous or semi-autonomous machine. The desired work path may be generated or defined by an operator (e.g., by providing geographic route data). Desired work paths, such as those generated using heuristics or historical data (e.g., a saved route recorded by a GPS receiver) may be stored by the machine controller 232 and/or a data storage device (e.g., an off-site storage location, the cloud, etc.) associated with the auxiliary machine 230. In some examples, a path planner (see U.S. patent application Ser. No. ______ (Attorney Docket No. 20241/P20988), which is hereby incorporated by reference) may be used to generate the desired path. The example machine controller 232 controls power to the wheels 240 from the ICE 246, generator 248, and/or motors 238 and controls steering any combination of the wheels 240. The example steering may be performed using any appropriate mechanical, electrical, hydraulic, or other similar mechanisms for turning the wheels 240 to steer the auxiliary machine 230.

FIG. 3 illustrates a block diagram of a fleet manager 110, which may implement the fleet manager 110 of FIG. 1. The example fleet manager 110 of FIG. 3 includes a communication bus 301 to facilitate communication between a data port 302, a data storage device 304, a user interface 306, a fleet identifier 308, a machine analyzer 310, a configuration analyzer 312, a mission analyzer 314, and a fleet assigner 316. The example mission analyzer 314 includes a task identifier 320, a task analyzer 322, and a site analyzer 324. The data port 302 may facilitate communication with the fleet of machines, other devices, operators of the machines (e.g., sending instructions indicating a work site the operators are to use the machines) and/or a network (e.g., the Internet) in communication with fleet manager 110. Accordingly, the data port 302 may facilitate wired and/or wireless communication with the fleet manager 110.

The data storage device 304 of FIG. 3 stores fleet management data including but not limited to operation data (e.g., type of operation (agricultural, construction, material handling, etc.), location of operation, etc.), fleet data (e.g., number and type of machines in the fleet, possible configurations of machines, machine schedules, etc.), work site data (e.g., characteristics of the work sites such as topography, soil conditions, vegetation conditions, etc.). The example data storage device 304 may store a database of the machines and/or possible machine configurations in the fleet indicating the machine characteristics, operation schedules indicating when or if they are in use, etc. Additionally, a database may be stored in the data storage device 304 indicating standard performance metrics for machine configurations to complete a task. For example, the standard performance metrics may be based on completing the task in ideal conditions (e.g., flat terrain, optimal soil conditions, etc.). In some examples, the data storage device 304 stores fleet management data generated from previous missions and/or from historical data generated by other machines or devices. In some examples, performance metric data for machine configurations to complete certain types of missions and/or work site data (e.g., soil conditions, topographic data, moisture conditions, weather data, etc.) may be retrieved from a network (e.g., the Internet) accessible by the fleet manager 110 via the data port 302 and stored in the data storage device 304.

The user interface 306 enables a user to access the data stored in the data storage device 304 and/or update the data in the data storage device 304. The user may also request the fleet manager 110 to make fleet assignments (i.e., assign machine configurations to work sites) via the user interface 306 and/or adjust preferred settings of the fleet manager 110 via the user interface 306.

The example fleet identifier 308 of FIG. 3 identifies machines (e.g., the machines 122, 124, 126, 132, 134, 136 of FIG. 1) in the fleet 120 that are available for use in the operation (e.g., some machines may be in use at other locations). Accordingly, the fleet identifier may track operation schedules of the machines 122, 124, 126, 132, 134, 136. In some examples, the fleet identifier 308 identifies machines via inputs from the user interface 306. The example machine analyzer 310 analyzes the types of machines (e.g., host machine, auxiliary machine, etc.), the characteristics of the machines 122, 124, 126, 132, 134, 136, etc. to generate and/or identify machine specification data.

The example configuration analyzer 312 determines potential configurations of the machines of the fleet based on machine specification data received from the machine analyzer 310. The example configuration analyzer 312 may identify certain rules, preferences, and/or characteristics of the machines in the data storage device 304 or from requests via the user interface 306 for making machine configurations. For example, a rule and/or preference may indicate that two certain machines (e.g., the host machines 122, 124 or the host machine 122 and the auxiliary machine 136) cannot be configured together (e.g., due to compatibility issues, user preferences, etc.).

The example mission analyzer 314 identifies the missions of fleet management system 100 the corresponding work sites where the missions are to be completed by the fleet 120. The mission analyzer 314 may identify the missions received by user request for a fleet assignment via the user interface 306. In some examples, the user request indicates the missions to be completed and their corresponding locations. The example mission analyzer 314 identifies tasks of the missions (e.g., plowing a field, tilling a field, removing snow, transporting materials, etc.) via the task identifier 320 that are to be completed. Certain tasks corresponding to the missions may be stored in the data storage device 304 and retrieved in response to an input from the user interface 306.

The example task analyzer 322 of FIG. 3 may identify needed equipment (e.g., an implement, such as a plow, tiller, seeder, cultivator, etc.) and/or power specifications for the machine configuration to complete the mission at the work site (e.g., an amount of power or steering capabilities needed to traverse a work path to complete the mission). Based on the configuration data from the configuration analyzer, equipment data, and power specification data, the example task analyzer 322 may identify, retrieve, and/or calculate one or more standard performance metric(s) (e.g., fuel consumption, power consumption, operating rate, CO2 or other emissions, time to complete mission, probability of completing the mission, etc.) for the identified machine configurations to complete the missions at the work site. The standard performance metrics may indicate expected performance metrics, such as fuel consumption, operating speed, power consumption, etc. in ideal conditions (e.g., flat ground, optimal soil conditions, etc.). The task analyzer 322 may retrieve the needed equipment, needed machine capabilities to perform the task(s), and/or standard performance metrics to perform the task(s) from the database 306.

The example site analyzer 324 of FIG. 3 identifies characteristics (e.g., soil conditions, topography, vegetation, etc.) of the work sites 140, 142, 144 fleet management system 100 that may affect power requirements and/or performance metrics. In some examples, the site analyzer 324 identifies performance multipliers to be applied to the power requirements and/or performance metrics for locations (e.g., cells) of the work sites 140, 142, 144. For example, muddy soil conditions may indicate that more power may be needed compared to normal soil conditions and that fuel consumption or other performance metrics may be affected (e.g., be lowered). The site analyzer 324 may also identify designated work paths that the machine configurations are to follow to complete the corresponding tasks. Accordingly, using the above information, the mission analyzer 314 identifies and/or calculates overall performance metrics (e.g., by multiplying the performance multipliers identified by the site analyzer 324 by the standard performance metrics identified by the task analyzer 322) for corresponding machine configurations to complete missions at the corresponding work sites 140, 142, 144.

The example fleet assigner 316 selects machine configurations to complete the corresponding missions at the corresponding work sites based on the overall performance metrics determined by the mission analyzer 314. In the illustrated example, the fleet assigner 316 identifies optimization settings (e.g., settings data stored in the data storage device 304, or input from the user interface 306) for assigning optimal configurations to the corresponding work sites. In some examples, the optimization settings may include hierarchies of preferred selection criteria for assigning the machine configurations to the work sites. For example, a user may select that the assignments are to primarily be based on power requirements, secondarily based on fuel costs, and finally time to complete all missions. In such an example, if multiple machine configurations can meet the power requirements at the work sites, then the assigning is based on the fuel costs, time to complete, etc. The example fleet assigner 316 may map (e.g., present in a table or diagram) the assignment of the machine configurations to the work sites on a display of the user interface 306. In some examples, when one or more of the machines (e.g., the machines 122, 124, 126, 132, 134, 136) of the fleet are autonomous or semi-autonomous, the fleet assigner 316 provides machine configuration data to the corresponding machines. One or more machine controller(s) (e.g., the machine controller 232 of FIG. 2) of the corresponding machine(s) may then automatically configure (e.g., mechanically connect or electrically connect) the machines according to the machine configuration data from the fleet assigner 316.

While an example manner of implementing the fleet manager 110 of FIG. 1 is illustrated in FIG. 3, one or more of the elements, processes and/or devices illustrated in FIG. 3 may be combined, divided, re-arranged, omitted, eliminated and/or implemented in any other way. Further, the data port 302, data storage device 304, the user interface 306, the fleet identifier 308, the machine analyzer 310, the configuration analyzer 312, the mission analyzer 314, the fleet assigner 316, the task identifier 320, the task analyzer 322, and the site analyzer 324 and/or, more generally, the example fleet manager 110 of FIG. 3 may be implemented by hardware, software, firmware and/or any combination of hardware, software and/or firmware. Thus, for example, any of the data port 302, data storage device 304, the user interface 306, the fleet identifier 308, the machine analyzer 310, the configuration analyzer 312, the mission analyzer 314, the fleet assigner 316, the task identifier 320, the task analyzer 322, and the site analyzer 324 and/or, more generally, the example fleet manager 110 of FIG. 3 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the data port 302, data storage device 304, the user interface 306, the fleet identifier 308, the machine analyzer 310, the configuration analyzer 312, the mission analyzer 314, the fleet assigner 316, the task identifier 320, the task analyzer 322, and/or the site analyzer 324 is/are hereby expressly defined to include a tangible computer readable storage device or storage disk such as a memory, a digital versatile disk (DVD), a compact disk (CD), a Blu-ray disk, etc. storing the software and/or firmware. Further still, the example fleet manager 110 may include one or more elements, processes and/or devices in addition to, or instead of, those illustrated in FIG. 3, and/or may include more than one of any or all of the illustrated elements, processes and devices.

A flowchart representative of a process 400 that may be implemented using example machine readable instructions for implementing the fleet manager 110 of FIG. 3 is shown in FIG. 4. In this example, the machine readable instructions comprise a program for execution by a processor such as the processor 812 shown in the example processor platform 800 discussed below in connection with FIG. 8. The program may be embodied in software stored on a tangible computer readable storage medium such as a CD-ROM, a floppy disk, a hard drive, a digital versatile disk (DVD), a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIG. 4, many other methods of implementing the example fleet manager 110 may alternatively be used. For example, the order of execution of the blocks may be changed, and/or some of the blocks described may be changed, eliminated, or combined.

As mentioned above, the example process of FIG. 4 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIG. 4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disk and to exclude propagating signals. As used herein, when the phrase “at least” is used as the transition term in a preamble of a claim, it is open-ended in the same manner as the term “comprising” is open ended.

An example process 400 that may be executed to implement the fleet manager 110 of FIG. 2 is represented by the flowchart shown in FIG. 4. With reference to the preceding figures and their associated descriptions, the process 400 of FIG. 4, upon execution (e.g., initiating the machine controller 110 (perhaps following a request for fleet assignment from a user)), causes the fleet manager 110 to begin analysis for assigning machine configurations to the work sites 140, 142, 144.

At block 402, the fleet identifier 308 identifies a fleet of machines in an operation. For example, the fleet identifier 308 may identify the three host machines 122, 124, 126 and the three auxiliary machines 132, 134, 136 of FIG. 1. In some examples, the fleet identifier 308 may identify a machine schedule in the data storage device 304 for machines of a work fleet indicating whether the machines are available for use (e.g., machines in the fleet may be unavailable due to maintenance, already in use for other missions, etc.). For example, with reference to FIG. 1, the fleet identifier may determine that one or more of the machine(s) 122, 124, 126, 132, 134, 136 is/are available for assignment but other machines (not shown) in the fleet 120 are not available. The fleet identifier 308 notifies the machine analyzer 310 of the available machines that can be configured and assigned to one or more of the work site(s) 140, 142, 144.

At block 404 of FIG. 4, the machine analyzer 310 identifies characteristics and/or power specifications of the machines 122, 124, 126, 132, 134, 136 of the fleet. For example, the machine analyzer 310 may identify machine characteristics, such as features (e.g., sensors or machine devices 224, 234, etc.) machine health, equipment, etc. and/or power specifications (e.g., power source type (ICE, hybrid electric, hybrid hydraulic, etc.), power rating (e.g. amount of horsepower or kWh the power source may provide), torque ratings, energy storage capacity, etc. of the machines 122, 124, 126, 132, 134, 136. In some examples, the machine analyzer 310 identifies features, such as the types of measurement devices 224, 234 (e.g., GPS receivers, sensors, gauges, etc.). For example, the machine analyzer 310 may determine that the first auxiliary machine 132 has less power traction and/or less energy storage capacity than the second auxiliary machine 134, which still further has less traction and/or less energy storage capacity than the third auxiliary machine 136 of FIG. 1.

At block 406 of FIG. 4, the example configuration analyzer 312 determines the potential machine configurations that can be arranged based on the available machines 122, 124, 126, 132, 134, 136 and their corresponding characteristics/features. In some examples, the configuration analyzer 312 identifies user preferences from settings (identifying rules for arranging machine configurations (e.g., stating that one particular machine or type of machine cannot be configured with another machine or type of machine, etc.) stored in the data storage device 304. The configuration analyzer 312 may determine one or more implement(s) (e.g., plow, cultivator, tiller, etc.) to be used with the machine configurations based on the type of missions that are to be completed at the work sites. For example, if the mission includes plowing a field, the configuration analyzer 312 may identify one or more plows (not shown) of various sizes, plow depths, etc. in the machine fleet 120. The configuration analyzer 312 may identify the types of missions from input via the user interface 306, from the data storage device 304, and/or data received from the mission analyzer 314.

As an example, referring to FIG. 5, the machine analyzer 310 provides machine information corresponding to the machines 122, 124, 126, 132, 134, 136 of the fleet 120 of illustrated example of FIG. 1 to the configuration analyzer 312. Based on the received machine data corresponding to the characteristics, features, etc. and configuration rules and/or constraints identified in the data storage device 306, the configuration analyzer 312 may determine the potential machine configurations. Identifying that the host machines 122, 124, 126 have different power capabilities, performance metrics, etc. and that auxiliary machines 132, 134, 136 have different power capabilities, the configuration analyzer 312 can identify a number of machine configurations 510 in the example of FIG. 5. The example machine configurations 510 may be configured with one or more of the host machines 122, 124, 126 and/or one or more auxiliary machines 132, 134, 136, etc. In the example of FIG. 1, a rule may state that the host machines 122, 124, 126 cannot be connected to form a machine configuration 510, but that the auxiliary machines 132, 134, 136 may be connected to each other and/or to the host machines 122, 124, 126.

In FIG. 5, the example machine configurations 510 are represented by the host machines 122, 124, 126 and the auxiliary machines 132, 134, 136. Using the rules and constraints (e.g., a host machine must be included in each of the configurations, or an auxiliary machine may be a single machine configuration if it has automatic control capabilities, specified orders that the machine may be connected machines may be constrained (e.g., based on tractive power transfer, operator visibility, operator preference, etc.), etc.) the configuration analyzer 312 generated a number of machine configuration. Though nine configurations are shown, the machine configuration analyzer 312 may have identified more or fewer than nine possible combinations and/or other types of combinations (e.g., a single auxiliary machine configuration, a multiple auxiliary machine configuration without a host machine, etc.).

In the illustrated example of FIG. 5, the machine configurations 520, 530, 540 are analyzed to determine an optimal assignment of the machine configurations to the work sites 140, 142, 144. The first machine configuration 520 includes the first host machine 122 connected to the first auxiliary machine 132. The second machine configuration 530 includes the second host machine 124 connected to the second auxiliary machine 134. The third machine configuration 540 is the third host machine 126 alone. In some examples, when there are more or fewer than three work sites of a fleet management system, more or fewer configurations than three configurations may be analyzed together to determine an fleet assignment. Furthermore, other example configurations 510 may be selected for analysis and/or may ultimately be selected for assignment in another analysis of the fleet management system 100.

Returning now to the example of FIG. 4, at block 408, the mission analyzer 314 begins a mission analysis process for missions (perhaps requested from a user via the user interface 306) that the machine fleet 120 is to perform at the work sites 140, 142, 144 of FIG. 1. The mission analyzer 314 calculates performance metrics for the machine configurations 520, 530, 540 to complete the identified missions of each of the work sites 140, 142, 144.

In the example of FIG. 4, the task identifier 320 identifies tasks (e.g., plow a field at 8 kilometers per hour (kph), etc.) of the missions to be completed at the work sites 140, 142, 144. In some examples, tasks and/or task information for the missions may be retrieved from a fleet assignment request input from a user via the user interface 306 and/or stored in a database of the data storage device 304.

At block 408, the task analyzer 322 determines standard performance metrics for the identified tasks and/or missions to be completed by the machine configurations 520, 530, 540 at the work sites 140, 142, 144. The task analyzer 322 may identify equipment, such as an implement (e.g., a plow, a tiller, a cultivator, a sprayer, a seeder, etc.), that is to be used for the missions of the work sites 140, 142, 144. In some examples, the data storage device 304 may have a database that stores standard performance metrics of the machines 122, 124, 126, 132, 134 and/or machine configurations 520, 530, 540 for completing the missions based on the machine characteristics, power specifications, machine configuration arrangement (i.e., how or in what order the machines 122, 124, 126, 132, 134 are connected to each other). The database in the data storage device 304 may include at least one of data indicating power ratings (e.g., in horsepower, kilowatts (kW), etc.), fuel cost values, operating speeds, CO2 or other emissions, total costs (e.g., fuel, labor, machine costs), and/or any other similar performance metrics that may be analyzed for the identified machines 122, 124, 126, 132, 134 and/or the machine configurations 520, 530, 540 to complete the tasks in ideal conditions (e.g., on flat ground, in optimal soil conditions, weather conditions, etc.). Accordingly, the task analyzer 322 may identify and retrieve the data from the database. In some examples, the task analyzer 322 may calculate the standard performance metrics for the machine configurations based on data (e.g., historical data from previous mission analyses for machines and/or machine configurations have similar characteristics and/or power specifications).

At block 410 of the illustrated example of FIG. 4, the site analyzer identifies characteristics (e.g., topography, muddy conditions, vegetation conditions/density, amount of snowfall, etc.) of the work sites 140, 142, 144 to determine a performance metric multiplier. The example site analyzer 324 may retrieve characteristic data of the work sites from the data storage device 304 and/or from input via the user interface 306. In some examples, the site analyzer 324 retrieves data corresponding to the work sites 140, 142, 144 from a network (e.g., the Internet) communicatively coupled to the fleet manager 110 via the data port 302. The site analyzer 324 may identify a work path for the machine configurations to complete the tasks. Geographic data representative of the work path may be stored in the database 304, and or a path planner may generate and provide a work path to be analyzed by the site analyzer 324. Based on the work site characteristics and the work path data, the site analyzer 324 may identify the performance metric multipliers for the machine 520, 530, 540 to complete the task at the work sites 140, 142, 144.

As an example, referring to FIGS. 6A-6B, the site analyzer 324 identifies the topography (e.g., from topographic data stored in the database 304, which may have been generated from previous missions completed at the work site 140, retrieved from topographic data databases, perhaps via the Internet, etc.) of the work site 140 of FIG. 6A. The site analyzer 324 divides the work site 140 into a number of work cells defined by a column identifier (e.g., C(1), C(2), . . . C(N) and a row identifier (e.g., R(1), R(2), . . . R(N)). Based on the topographical information, the site analyzer 324 generates a table 600 of performance metric multipliers (e.g., 4.1 of Cell (C(1), R(1))), as shown in FIG. 6B. The performance metric multipliers of FIG. 6B are based on the characteristics and power specifications for the first machine configuration 520 to complete the mission at the work site 140. In some examples, the performance metric multiplier for the first machine configuration 520 are modified from the topographic analysis based on soil conditions, vegetation conditions, expected crop yield, etc. at the work site 140. For example, muddy soil conditions and/or dense vegetation may increase the impact of the performance metric multiplier. Similar tables 600 may be generated for the second and third machine configurations 530, 540 to complete mission at the work site 140. For example, the performance multipliers for the third machine configuration 540 may be increased because the machine configuration 540 comprises only the third host machine 126 (e.g., muddy conditions may have more of an impact on a single machine than a multiple machine configuration that has more ground engaging elements for traction). Furthermore, tables similar to the table 600 of FIG. 6B may be generated for the machine configurations 520, 530, 540 to complete the missions at the second and third work sites 142, 144.

At block 412 of the illustrated example of FIG. 4, Using the performance metrics data from the task analyzer 322 and the site analyzer 324, the mission analyzer 314 can determine overall performance metrics for the machine configurations 520, 530, 540 in the example of FIG. 1. For example, in FIG. 6B, the performance metric multipliers may represent a percentage impact on the performance metrics. For example, fuel costs in Cell (C1, R1) may be affected by a 4.1% increase and in Cell (C6, R4) by a 6.8% increase for the first machine configuration 520. Accordingly, the standard performance metrics determined by the task analyzer 322 for the machine configuration 520 may be combined (e.g., multiplied, added, subtracted, etc.) with the performance metric multipliers determined by the site analyzer 324 for the machine configuration 520 to determine an overall performance metric for one of the machine configuration 520 to complete the missions at the work site 140. Accordingly, similar computations may be made for the second and third machine configuration 530, 540 at the work site 140, and for the machine configurations 520, 530, 540 at the second and third work sites 142, 144.

Referring to FIG. 7 as an example, the mission analyzer 314 may generate a table 700 for assignment analysis. The table 700 presents an analysis of a fuel cost performance metric to make an optimal assignment of the machine configurations 520, 530, 540 to the work sites 140, 142, 144, though other performance metrics may alternatively or additionally be included in the table 700. In FIG. 7, the table 700 includes possible assignment scenarios (1-6, . . . , ‘X’) identified in column 902. In the illustrated example of FIG. 7, only data for the six possible scenarios for the example machine configurations 520, 530, 540 to be assigned to the work sites 140, 142, 144 is populated. However, a full analysis of all possible machine configurations 510 to be assigned to the work sites 140, 142, 144 of FIG. 1 would include ‘X’ scenarios. Column 704 of the table 700 lists the work site identifiers (e.g., 140, 142, 144) and column 706 lists the machine configuration identifiers (e.g., 520, 530, 540) representative of the machine configurations 520, 530, 540 to be assigned to the corresponding work site 140, 142, 144 of the row of the Scenarios 1-6.

Column 708 of FIG. 7 lists the estimated fuel costs per machine configuration 520, 530, 540 to complete the tasks at the corresponding work site 140, 142, 144 using the overall performance metrics. For example, in Scenario 1 of FIG. 7, a standard fuel cost to complete the mission of the work site 140 in ideal conditions may be less than or more than the $209 depending on the performance metric multiplier for the work site 140. Column 710 identifies the total cost for completing the missions for the corresponding assignment scenario 1-6. Column 712 of the table 700 may include a secondary performance metric to be considered if the Total Cost performance metric 710 would not provide clear results for making an optimal assignment (e.g., all scenarios meet the preferred performance metric such as a power requirement, the differences in the total costs were within a threshold value or standard deviation from each other, such as within a probably of error).

In the example of FIG. 7, the assignment Scenario 4 provides the optimal assignment for minimizing the total fuel cost at $1034 for the machine configurations 520, 530, 540 to be assigned to the work sites 140, 142, 144. In scenario 4, the first machine configuration 520 would be assigned to third work site 144, the second machine configuration 530 would be assigned to the second work site 140, and the third machine configuration 540 would be assigned to the first work site 140. However, other machine configurations 510 of FIG. 5 may prove to be more cost effective than scenario 4, and thus the configurations 520, 530, 540 may not ultimately be assigned to the work sites 144, 142, 140, respectively, according to the examples of FIGS. 1, 5, 6, and 7. The table 700 may be presented to a user via the user interface 306.

At block 414, using the overall performance metric data (e.g., the data of table 700) from the mission analyzer 314, the fleet assigner 316 may assign the machine configurations 520, 530, 540 to the work sites 144, 142, 140 based on optimization settings of the performance metrics and/or other machine configurations 510 which may in Scenarios 6—‘X’. In the event that the machine configuration 520, 530, 540 provides the optimal assignment for all possible configurations 510 to be assigned to the work sites 140, 142, 144, the fleet assigner 316 assigns the first machine configuration 520 to the third work site 144, the second machine configuration 530 to the second work site 140, and the third machine configuration 540 to the first work site 140. The fleet assigner 316 may use other performance metrics described above, and/or a hierarchy of performance metrics for making an optimization assignment.

In some examples, at block 414, the fleet assigner 316 provides the fleet assignment to a user and/or machine operator via the user interface 304 or via the data port 302 to other device(s) (e.g., a mobile device such as a cell phone, tablet computer, etc.) in communication with the fleet manager 110. In some examples, the fleet manager 110 may wirelessly communicate with other device(s) via the data port 302 by sending the machine configuration assignment data (e.g., via text message, instant message, e-mail, etc.). After block 410, the process 400 ends.

FIG. 8 is a block diagram of an example processor platform 800 capable of executing the instructions of FIG. 8 to implement the fleet manager 110 of FIGS. 1 and/or 3. The processor platform 800 can be, for example, a server, a personal computer, a mobile device (e.g., a cell phone, a smart phone, a tablet such as an iPad™), a personal digital assistant (PDA), an Internet appliance, or any other type of computing device.

The processor platform 800 of the illustrated example includes a processor 812. The processor 812 of the illustrated example is hardware. For example, the processor 812 can be implemented by one or more integrated circuits, logic circuits, microprocessors or controllers from any desired family or manufacturer.

The processor 812 of the illustrated example includes a local memory 813 (e.g., a cache). The processor 812 of the illustrated example is in communication with a main memory including a volatile memory 814 and a non-volatile memory 816 via a bus 1018. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, one or more input devices 822 are connected to the interface circuit 820. The input device(s) 822 permit(s) a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), and/or speakers). The interface circuit 1020 of the illustrated example, thus, typically includes a graphics driver card, a graphics driver chip or a graphics driver processor. The input device(s) and output device(s) may implement the user interface 306 of FIG. 3.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes one or more mass storage devices 828 for storing software and/or data. Examples of such mass storage devices 828 include floppy disk drives, hard drive disks, compact disk drives, Blu-ray disk drives, RAID systems, and digital versatile disk (DVD) drives.

The coded instructions 832 of FIG. 4 may be stored in the mass storage device 828, in the volatile memory 814, in the non-volatile memory 816, and/or on a removable tangible computer readable storage medium such as a CD or DVD. The mass storage device 828, volatile memory 814, the non-volatile memory 816, and/or a removable tangible storage computer readable medium may implement the data storage device 304 of FIG. 3

From the foregoing, it will appreciate that the above disclosed methods, apparatus and articles of manufacture provide fleet manager to automatically assign machines and/or machine configurations to work sites of an operation based on performance metrics measured from characteristics of the machines and/or performance multipliers measured from characteristics of the work sites. The fleet manager may identify an optimal machine configuration comprising one or more machines to complete one or more mission(s) at various work sites of a fleet management system.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
determining a first performance metric for a first machine configuration to execute a mission at a work site based on a characteristic of the first machine configuration or a characteristic of the work site;
determining a second performance metric for a second machine configuration to execute the mission at the work site based on a characteristic of the second machine configuration or a characteristic of the work site; and
assigning the first machine configuration to the work site for execution of the mission based on a comparison of the first and second performance metrics.

2. A method according to claim 1, wherein the mission is a first mission and the work site is a first work site, the method further comprising:
determining a third performance metric for the first machine configuration to execute a second mission at a second work site based on a characteristic of the first machine configuration or a characteristic of the work site;
determining a fourth performance metric for the second machine configuration to execute the second mission at the work site based on a characteristic of the second machine configuration or a characteristic of the work site; and
assigning the first machine to the first work site to execute the first mission and assigning the second machine to the second work site to execute the second mission based on comparing a sum of the first performance metric and the fourth performance metric to a sum of the second performance metric and the third performance metric.

3. A method according to claim 1, wherein the first machine configuration comprises a host machine operated by a user and at least one of an autonomous auxiliary machine or a semi-autonomous operated auxiliary machine.

4. A method according to claim 3, wherein the at least one of the autonomous auxiliary machine or the semi-autonomous auxiliary machine comprises an energy storage device to store energy charged during execution of the mission.

5. A method according to claim 1, further comprising:
determining a performance multiplier based on the characteristics of the work site;
calculating a first overall performance metric by adjusting the first performance metric using the performance multiplier; and
calculating a second overall performance metric by adjusting the second performance metric using the performance multiplier,
wherein assigning the first machine configuration is based on a comparison of the first overall performance metric and the second overall performance metric.

6. A method according to claim 1, further comprising determining whether the first machine configuration is capable of executing the mission to completion based on a power rating or an energy storage capacity of the first machine configuration and an estimated power requirement to complete the mission.

7. A method according to claim 1, wherein the comparison of the first performance metric to the second performance metric indicates that the first performance metric is more optimal than the second performance metric, wherein the first and second performance metric comprise a minimum power needed to complete the mission, a minimum fuel cost, a minimum emissions, or minimum length of time to complete the missions.

8. An apparatus comprising:
a mission analyzer to determine a first performance metric for a first machine configuration to execute a mission at a work site based on a characteristic of the first machine configuration or a characteristic of the work site and a second performance metric for a second machine configuration to execute the mission at the work site based on a characteristic of the second machine configuration or a characteristic of the work site; and
a fleet assigner to assign the first machine configuration to the work site for execution of the mission based on a comparison of the first and second performance metrics.

9. An apparatus according to claim 8, wherein
the mission analyzer is further to determine a third performance metric for the first machine configuration to execute a second mission at a second work site based on a characteristic of the first machine configuration or a characteristic of the work site and a fourth performance metric for the second machine configuration to execute the second mission at the work site based on a characteristic of the second machine configuration or a characteristic of the work site,
wherein the fleet assigner is to assign the first machine to the first work site to execute the first mission and assigning the second machine to the second work site to execute the second mission based on comparing a sum of the first performance metric and the fourth performance metric to a sum of the second performance metric and the third performance metric.

10. An apparatus according to claim 8, wherein the machine configuration comprises a host machine operated by a user and at least one of an autonomous auxiliary machine or a semi-autonomous operated auxiliary machine.

11. An apparatus according to claim 10, wherein the at least one of the autonomous auxiliary machine or the semi-autonomous auxiliary machine comprises an energy storage device to store energy charged during execution of the mission.

12. An apparatus according to claim 8, further comprising a site analyzer to determine a performance multiplier based on characteristics of the work site, calculate a first overall performance metric by adjusting the first performance metric using the performance multiplier, and calculate a second overall performance metric by adjusting the second performance metric using the performance multiplier,
wherein the fleet assigner is to assign the first machine configuration based on a comparison of the first overall performance metric and the second overall performance metric.

13. An apparatus according to claim 8, further comprising a configuration analyzer to determine whether the first machine configuration is capable of executing the mission completion based on a power rating or an energy storage capacity of the first machine configuration and an estimated power requirement to complete the mission.

14. An apparatus according to claim 8, wherein the comparison of the first performance metric to the second performance metric indicates that the first performance metric is more optimal than the second performance metric, wherein the first and second performance metric comprise a minimum power needed to complete the mission, a minimum fuel cost, a minimum emissions, or minimum length of time to complete the missions.

15. A tangible computer readable storage medium comprising instructions that, when executed cause a machine to at least:
determine a first performance metric for a first machine configuration to execute a mission at a work site based on a characteristic of the first machine configuration or a characteristic of the work site;
determine a second performance metric for a second machine configuration to execute the mission at the work site based on a characteristic of the second machine configuration or a characteristic of the work site; and
assign the first machine configuration to the work site for execution of the mission based on a comparison of the first and second performance metrics.

16. A storage medium according to claim 15, wherein the instructions when executed cause the machine to:
determine a third performance metric for the first machine configuration to execute a second mission at a second work site based on a characteristic of the first machine configuration or a characteristic of the work site;
determine a fourth performance metric for the second machine configuration to execute the second mission at the work site based on a characteristic of the second machine configuration or a characteristic of the work site; and
assign the first machine to the first work site to execute the first mission and assigning the second machine to the second work site to execute the second mission based on comparing a sum of the first performance metric and the fourth performance metric to a sum of the second performance metric and the third performance metric.

17. A storage medium according to claim 15, wherein the first machine configuration comprises a host machine operated by a user and at least one of an autonomous auxiliary machine or a semi-autonomous operated auxiliary machine.

18. A storage medium according to claim 17, wherein the at least one of the autonomous auxiliary machine or the semi-autonomous auxiliary machine comprises an energy storage device to store energy charged during execution of the mission.

19. A storage medium according to claim 15, wherein the instructions when executed cause the machine to:
determine a performance multiplier based on the characteristics of the work site;
calculate a first overall performance metric by adjusting the first performance metric using the performance multiplier; and
calculate a second overall performance metric by adjusting the second performance metric using the performance multiplier; and
assign the first machine configuration is based on a comparison of the first overall performance metric and the second overall performance metric.

20. A storage medium according to claim 15, wherein the instructions when executed cause the machine to determine whether the first machine configuration is capable of executing the mission to completion based on a power rating or an energy storage capacity of the first machine configuration and an estimated power requirement to complete the mission.

21. (canceled)
